(19) United States
(12) Patent Application Publication
(10) Pub. No.: US 2021/0403134 A1
(43) Pub. Date: Dec. 30, 2021

(54) SOFT ATTACHMENT DEVICE AND METHOD OF USE

(71) Applicant: TEDTEC PTY LTD, Helensburgh, New South Wales (AU)

(72) Inventor: Andrew YORK, Picton (AU)

(21) Appl. No.: 17/291,593

(22) PCT Filed: Oct. 24, 2019
(86) PCT No.: PCT/AU2019/000134

§ 371 Date: May 5, 2021

(30) Foreign Application Priority Data
Nov. 5, 2018 (AU) 2018904204

(51) Int. Cl. B63H 9/10; B63B 21/04

(52) U.S. Cl. CPC B63H 9/10; B63B 21/04

(57) ABSTRACT

The invention relates to a soft attachment for anchoring on a surface including a wall, deck of a boat or spar of a boat and a method of connecting the soft attachment to a surface. The soft attachment comprises:
a hollow shank having a first end port, a second end port, an inner surface and a threaded outer surface,
a flange located adjacent the first end port of the shank, and
at least one flexible elongate member having a first portion located adjacent the inner surface of the hollow shank, and a second portion projecting from said first end port for use as an anchoring point for attachment of rigging.

### FIELD OF INVENTION

The present invention relates to the field of fastening devices.

In one form, the invention relates to a fastening device suitable for attachment to a boat hull or fittings.

In one particular aspect the present invention is suitable for use as a soft attachment for marine shrouds, riggings, cables, superstructure members or the like

It will be convenient to hereinafter describe the invention in relation to fastening blocks associated with boats, however the present invention is not limited to that application. It should be appreciated that the application of the present invention is much broader and extends to securement of a wide range of elements, particularly those subject to tension such as shrouds, riggings, cables, superstructure members or the like.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Boats, particularly sailing boats, typically comprise complex systems of rigging comprising elements such as ropes, straps, cables and chains which support and operate the masts, spars and sails. Some rigging elements may be associated with other aspects of boat superstructure, including the steering. Many of the ropes, cables and chains need to be tensioned and fastened at one end to a flat surface. One of the important components of rigging is the ‘block’, which is a single, or multiple pulley. In use, a block is fixed to the end of a rope, to a spar or to a surface.

One well known attachment device of the prior art comprises a plate and a counter-plate disposed on either surface of a wall or deck and held together with screws. The plate is then mounted with a rigid anchoring ring. Assembly requires two people, one on either side of the wall or deck. Furthermore, multiple screw holes must be drilled in the wall or deck, potentially compromising its strength

Attachments of blocks to boats have been either ‘hard’ or ‘soft’. Hard attachments include metal shackles, jaws, eyes or hooks.

Soft attachments rely on a flexible connection element such as a rope. With advances in materials technology, there is an increased demand for lighter, stronger, faster equipment and with it, an evolving trend towards soft-rope attachments. Some high-strength and low-stretch synthetic fibre ropes are stronger than steel wire, yet lighter than a steel shackles and buoyant enough to float in water. Soft attachment options tend to be more flexible and allow better articulation than a metal shackle. They allow a load pulled through a block to be at an optimal angle, reducing the risk of breakage and space taken up on deck.

Soft attachments are ideal for traveller controls, mainsheets and vangs, cascades, bridles and other systems requiring lightweight blocks. They are also used for connection to mastbase blocks, spinnaker sheet turning blocks, halyard terminals, footblocks, tie-downs, and leaning straps.

U.S. Design Pat. No. D704,593 to Tamme (Ropeye Ou) depicts a fastening device comprising a carbon or glass fibre disk with a rope loop projecting from the centre (FIG. 1). For low loads, the fastening device can be attached to the deck by adhesive applied to the lower surface of the glass fibre disk to adhere it to the deck surface.

To secure high loads or loads at an angle of more than 10 degrees, it is preferable to use through-deck pushing. These comprise a hollow shank that resides in a hole in the deck, each end of the shank having a flange—an upper flange resting on the upper surface of the deck, and a lower flange located adjacent the under surface of the deck. A curved pad may be added to the lower flange to distribute live loads evenly across the device irrespective of the loading angle.

### SUMMARY OF INVENTION

An object of the present invention is to provide an attachment device that can be rapidly mounted by a single person.

Another object of the present invention is to provide a soft attachment adapted to work about 360°.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a soft attachment for anchoring on a surface including a wall, deck of a boat or spar of a boat, the soft attachment comprising:

a hollow shank having a first end port, a second end port, an inner surface and a threaded outer surface,

a flange located adjacent the first end port of the shank,

at least one flexible elongate member having a first portion located adjacent the inner surface of the hollow shank, and a second portion projecting from said first end port for use as an anchoring point for attachment of rigging.

Typically, the flexible elongate member comprises high-strength and low-stretch synthetic fibre such as nylon, polyester, polypropylene, polyethylene or combinations thereof. In a preferred embodiment, the flexible elongate member comprises sailing or yachting rope formed from an ultra-high molecular weight polyethylene (UHMWP) based fibre such as those sold under the names Dyneema™ from DSM or Spectra™ from Honeywell, Dynice® from Hampidjan.

In one embodiment, the flexible elongate member second portion projects as a loop from the first end port. Alternatively, the second portion of the flexible elongate member projects as a free end. In another embodiment, the free ends of two flexible elongate members project from the first end port. Typically the flexible elongate member second portion in use holds a fitting for rigging.

In a particularly preferred embodiment of the present invention, the elongate member is a length of yachting rope that projects from the first end port as a loop, and the two ends of the rope are tied in a knot that projects from the second end port of the hollow shank. The elongate member is thus restrained from pulling through the hollow shank. The elongate member may be similarly restrained by many other means.

In another aspect of embodiments described herein there is provided a method of installing the soft attachment of the present invention, the method comprising the steps of:

providing a recess in a wall, deck or spar of a boat, and

rotating the hollow shank in the recess such that the threaded outer surface of the hollow shank is retained within the hole, the first end port being adjacent the surface.

In one embodiment, the threaded outer surface bites into the wall of the recess as it is rotated. In another embodiment, the wall of the recess comprises a threaded surface that mates with the thread on the outer surface of the hollow shank.

Other aspects and preferred forms are disclosed in the specification and/or defined in the appended claims, forming a part of the description of the invention.

In essence, embodiments of the present invention stem from the realization that a secure soft attachment can be secured from one side of a deck or wall in a manner that ensures it has minimal protrusion and can bear significant loads.

Advantages provided by the present invention comprise the following:

provides a light, soft, strong attachment that can work about 360°;

can be installed by one person on one side of a wall or deck. Prior art attachments typically require one person on either side of a wall or deck;

can be used on the decks where there is no underside access (eg cockpit floor) and spars (eg masts and booms) where no other near flush fittings can be used because they require a part to screw in from the back;

inexpensive to manufacture compared to many attachments of the prior art;

can support a load of hundreds of kilograms—with the addition of a nut and washer on the underside the load may be increased.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1, FIG. 2, FIG. 3 and FIG. 4 illustrates a soft attachments of the prior art;

FIG. 5 illustrates a perspective view of a soft attachment device according to the present invention; and

FIG. 6 illustrates the hollow shank of the soft attachment device of FIG. 5 in perspective (FIG. 6A) and in longitudinal cross section (FIG. 6B).

### DETAILED DESCRIPTION

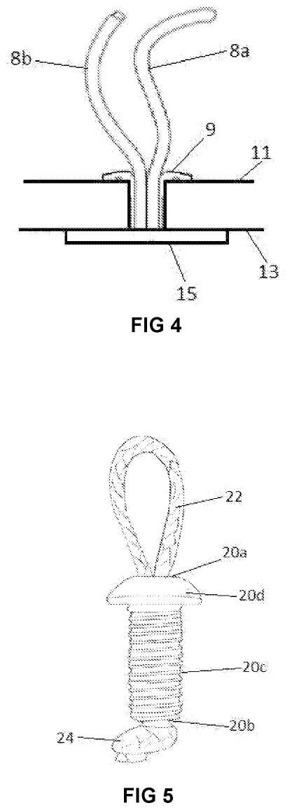

For purposes of description herein, the terms “upper,” “lower,” “right,” “left,” “rear,” “front,” “vertical,” “horizontal,” “interior,” “exterior,” and derivatives thereof shall relate to the invention as oriented in FIG. 5. However, it is to be understood that the invention may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

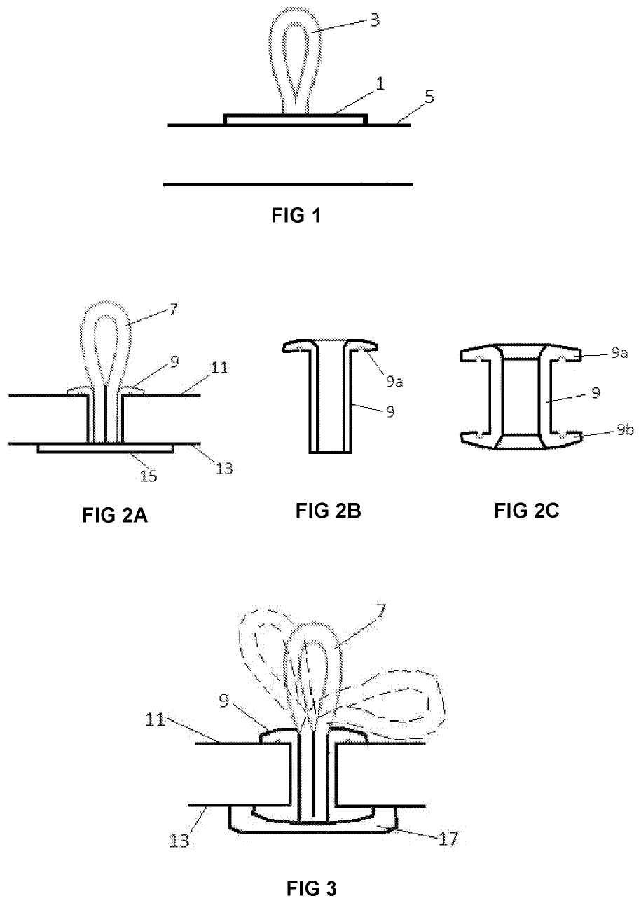

FIG. 1 depicts a depicts a soft attachment device of the prior art known as a ‘softeye’ comprising a carbon or glass fibre disk (1) with a rope loop (3) projecting from the centre of the disk (1). The softeye is typically attached to the upper surface (5) of a deck by a thin layer of adhesive. FIG. 4 depicts the soft attachment of FIG. 1 that includes a pair of rope ties (8a, 8b) instead of a rope loop.

To secure high loads or loads at an angle of more than 10 degrees, the prior art has included a ‘through-deck pushing’ of the type depicted in FIG. 2. FIG. 2 depicts a rope loop (7) located in a pushing (9) which lines and reinforces a hole drilled in a deck. The rope loop (7) can pass through the upper surface (11) of the deck while the disk (15) remains on the lower surface (13) of the deck, anchoring the rope loop (7). The pushing (9) is depicted in greater detail in FIG. 2B and includes an upper flange (9a) which in use is located adjacent the upper surface (11). FIG. 2C depicts another version of the pushing (9) which includes an upper flange (9a) and a lower flange (9b). Typically the mating parts of the prior art screw together.

FIG. 3 depicts another version of the through deck pushing of FIG. 2 which includes a curved pad 17 that is added to the lower flange (9b) shaped to distribute live loads evenly across the device to better withstand the force imparted as the rope loop 7 is loaded at different angles, depicted by dotted lines.

FIG. 5 is a perspective view of a soft attachment according to the present invention for anchoring on a wall or deck of a boat. The soft attachment comprises a hollow shank (20) having a first end port (20a), a second end port (20b) and a threaded outer surface (20c). A flange (20d) is located adjacent the first end port (20a) of the shank. A flexible rope loop (22) projects from the first end port (20a). The body of the loop is located within the hollow shank (20) and the ends of the loop are tied in a knot (24) adjacent the second end port (20b)

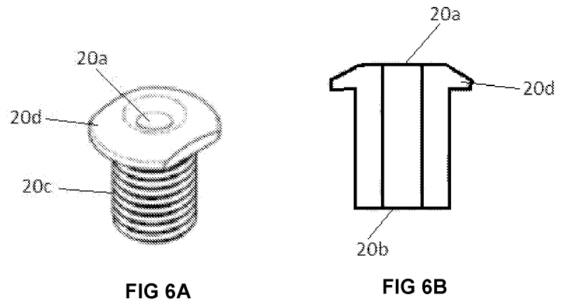

FIG. 6 depicts the hollow shank of the device of FIG. 5. FIG. 6A is a perspective view of the shank and FIG. 6B is a view of the vertical cross section.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A soft attachment for anchoring on a surface, the soft attachment comprising:
a hollow shank having a first end port, a second end port, an inner surface and a threaded outer surface,
a flange located adjacent the first end port of the shank,
at least one flexible elongate member having a first portion located adjacent the inner surface of the hollow shank, and a second portion projecting from said first end port for use as an anchoring point for attachment of rigging.

2. The soft attachment according to claim 1 when anchored on a surface chosen from a wall, deck of a boat or a spar.

3. The soft attachment according to claim 1 when attached to rigging elements of a boat.

4. The soft attachment according to claim 1 wherein the flexible elongate member comprises high-strength and low-stretch synthetic fibre.

5. The soft attachment according to claim 1 wherein the flexible elongate member second portion projects as a loop from the first end port.

6. The soft attachment according to claim 1 wherein the flexible elongate member second portion projects as a loop from the first end port and holds a fitting.

7. The soft attachment according to claim 1 wherein the flexible elongate member second portion projects as a free end.

8. The soft attachment according to claim 1 wherein the flexible elongate member second portion projects as two free ends.

9. A method of installing the soft attachment of claim 1, the method comprising the steps of:
providing a recess in a surface, and
rotating the hollow shank in the recess such that the threaded outer surface of the hollow shank is retained within the hole, the first end port being adjacent the surface.

10. The method of installing the soft attachment according to claim 9 wherein during rotation, the threaded outer surface of the hollow shank bites into the surface of the recess.

11. The method of installing the soft attachment according to claim 9 wherein during rotation, the threaded outer surface of the hollow shank mates with a thread at the surface of the recess.

12. The method according to claim 9 when carried out by one person adjacent the surface on one side of a structure.
